(19) United States
(12) Patent Application Publication
(10) Pub. No.: US 2016/0078133 A1
(43) Pub. Date: Mar. 17, 2016

(54) CONTENT INTERFACE LAYOUT CONSTRUCTION

(71) Applicant: Microsoft Corporation, Redmond, WA (US)

(72) Inventors: Deepak Santhanam, Seattle, WA (US); Arun Sacheti, Sammamish, WA (US); Yandong Guo, Bellevue, WA (US); Parthasarathy Govindarajen, Bothell, WA (US); Mikhail Valeryevich Parakhin, Seattle, WA (US)

(21) Appl. No.: 14/487,032

(22) Filed: Sep. 15, 2014

(51) Int. Cl. G06F 17/30; G06F 3/0482; G06F 3/0484; G06F 3/0485

(52) U.S. Cl. CPC G06F 17/30867; G06F 17/3053; G06F 17/30528; G06F 3/0485; G06F 3/0482; G06F 3/04842

(57) ABSTRACT

One or more techniques and/or systems are provided for constructing a content interface layout. For example a search query may be received from a user of a device. A content interest context for the user may be identified (e.g., a time of day, a season, a user location, a user social network post about planting a garden, device type of the user, etc.). Content interfaces (e.g., a gardening image collection, a tomato planting instructional app, a soil related topic search suggestion, etc.) may be populated within content interface slots of a search results canvas for the search query based upon user engagement metrics and the content interest context. In this way, content interfaces, comprising supplemental content, may be assigned to content interface slots so that such content interfaces have a high probability of being relevant to and/or engaged by the user.

### BACKGROUND

Many users may utilize search interfaces to discover, explore, and engage with content such as to complete a task. In an example, a user may submit a search query “tomato based cooking recipes” to a search engine. The search engine may provide the user with search results that are relevant to tomato cooking recipes. In another example, the user may submit various search queries relating to vacations, car rentals, and hotels to the search engine in order to obtain search results that may be used to plan a vacation.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for constructing a content interface layout are provided herein. In an example, a search query is received from a user of a device. A content interest context for the user may be identified. A search results canvas for the search query may be segmented into a set of content interface slots. A first user engagement metric may be assigned to a first content interface slot within the set of content interface slots. A second user engagement metric may be assigned to a second content interface slot within the set of content interface slots. A content interface layout may be constructed on the search results canvas. For example, a first content interface, comprising first supplemental content associated with the search query, may be assigned to the first content interface slot based upon the first user engagement metric and the content interest context. A second content interface, comprising second supplemental content associated with the search query, may be assigned to the second content interface slot based upon the second user engagement metric and the content interest context.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of constructing a content interface layout.

FIG. 2A is a component block diagram illustrating an exemplary system for constructing a content interface layout, where user engagement metrics are assigned to content interface slots.

FIG. 2B is a component block diagram illustrating an exemplary system for constructing a content interface layout, where content interfaces are assigned to content interface slots.

FIG. 2C is a component block diagram illustrating an exemplary system for constructing a content interface layout, where user engagement metrics are assigned to content interface slots.

FIG. 2D is a component block diagram illustrating an exemplary system for constructing a content interface layout, where content interfaces are assigned to content interface slots.

FIG. 3A is a component block diagram illustrating an exemplary system for constructing a content interface layout for a first user, where user engagement metrics are assigned to content interface slots.

FIG. 3B is a component block diagram illustrating an exemplary system for constructing a content interface layout for a first user, where content interfaces are assigned to content interface slots.

FIG. 3C is a component block diagram illustrating an exemplary system for constructing a content interface layout for a second user, where user engagement metrics are assigned to content interface slots.

FIG. 3D is a component block diagram illustrating an exemplary system for constructing a content interface layout for a second user, where content interfaces are assigned to content interface slots.

FIG. 4 is an illustration of an exemplary computer readable medium wherein processor-executable instructions configured to embody one or more of the provisions set forth herein may be comprised.

FIG. 5 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more systems and/or techniques for constructing a content interface layout are provided herein. A user may desire to discover and explore content and/or perform tasks using information exposed through search results (e.g., the user may submit a query “tomatoes” to a search engine). However, different users may have different search intents for the same search query (e.g., Joe want may to plant tomatoes whereas Mary may want to cook a tomato based dinner). Accordingly, as provided herein, a search results canvas may be segmented into a set of content interface slots (e.g., regions of a search engine results page), and content interfaces, comprising supplemental information, may be assigned to content interface slots based upon a content interest context (e.g., a location of Joe being in a backyard garden, a device type, a browser type, a social network post by Joe about gardening today, a previous search query, a user profile, a time of day, etc.) and/or user engagement metrics (e.g., a likelihood a user may interact with a content interface given the search query, the content interest context, a position of the content interface, etc.). In this way, a content interface, comprising highly engaging and interesting supplemental content for the user, may be assigned to a content interface slot having a relatively high user engagement metric to create a content interface layout on the search results canvas. Thus, the user may easily consume supplemental content (e.g., the content interface layout may be arranged with content interfaces accordingly to a layout that may be visually appealing and easily discernable for a user, such as being formatted for display on mobile device having a small display form factor). Because content interfaces may be arranged such that relatively more engaging content interfaces (e.g., a gardening instructions content interface for Joe) are assigned to content interface slots having relatively higher user engagement (e.g., a highly visible topmost part of a search results canvas), a user may quickly identify relevant supplemental content that may aid the user in efficiently completing a task. In this way, higher user engagement may be achieved (e.g., because highly engaging supplemental content may be displayed in a prominent location of the search results canvas). It will be appreciated that the user may take affirmative action, such as providing opt-in consent, to allow access to and/or use of information (e.g., social network posts, calendar entries, photos, messages, a video that the user is currently watching, music that the user is currently listening to, etc.), such as for the purpose of identifying a content interest context and/or for constructing a content interface layout (e.g., where the user responds to a prompt regarding the collection and/or use of such information).

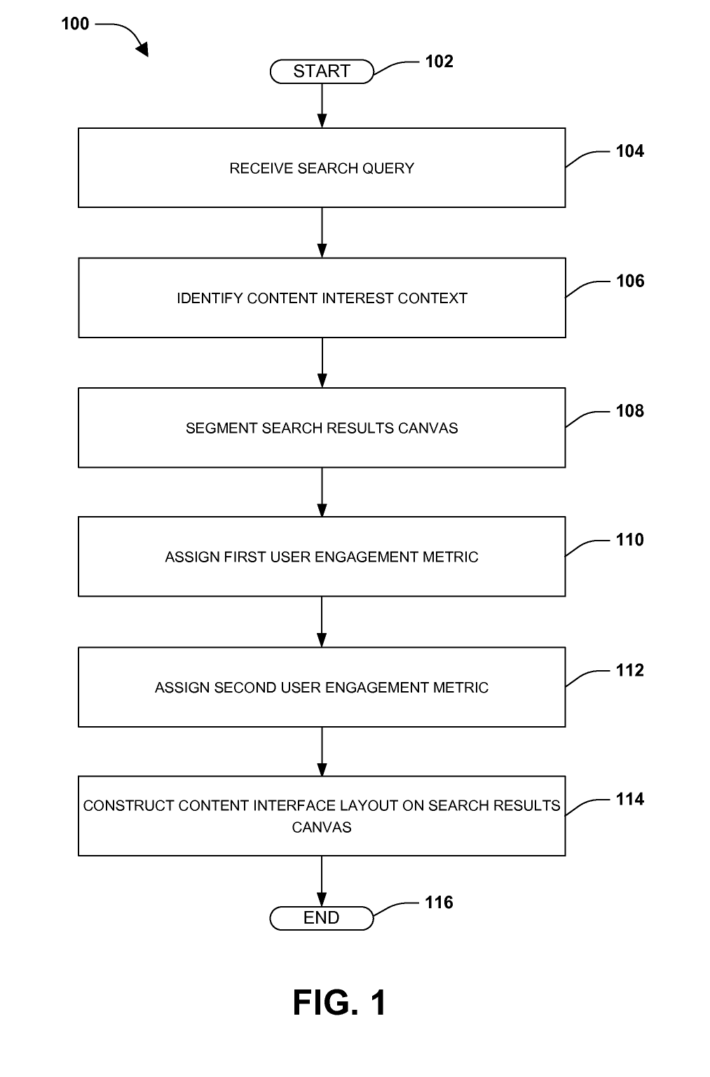

An embodiment of constructing a content interface layout is illustrated by an exemplary method 100 of FIG. 1. At 102, the method starts. At 104, a search query may be received from a user of a device. For example, a user may submit a search query “beach fun” using a mobile device while at a beach location in the morning. At 106, a content interest context for the user may be identified based upon, for example, user contextual information of the user, device contextual information of the device, and/or search query contextual information of the search query. In an example, the context interest context may correspond to a current date and/or time, a query intent, a relevancy between the search query and supplemental content of a content interface, a device type, a user location, a browser type, a user task, previously engaged content, a previously submitted search query, a quality metric for the content interface, a user profile, etc. For example, the content interest context may corresponding to a beach location, a morning time, a social network post “Swimming today!” by the user, a device form factor of the mobile device, a browser of the mobile device, etc.

At 108, a search results canvas (e.g., a search engine results page) for the search query may be segmented into a set of content interface slots. For example, regions of the search results canvas may be designated as content interface slots to which content interfaces, comprising supplemental content (e.g., related topics, collections of images, collections, of videos, search suggestions, bookmark suggestions, social network suggestions, a suggestion to add a content feed to an operating system user interface element such as a tile, etc.), may be assigned. Content interface slots may be interspersed with search query results, such as above, below, and/or adjacent to website search query results that may be relevant to the search query “beach fun”. In an example, a content interface slot may comprise a horizontally scrollable interface slot within which one or more content interfaces may be populated such that a user may horizontally scroll between content interfaces (e.g., scroll between a beach image collection content interface, a fishing image collection content interface, a vacation video collection content interface, a beach vacation stories collection content interface, etc.). In an example, a content interface slot may comprise an inline interface slot positioned between one or more search query results. In an example, the content interface slot comprises a side rail interface slot positioned adjacent to a search query result. It will be appreciated that any number and/or type(s) of content interface slots are contemplated (e.g., vertically scrollable instead of or in addition to horizontally scrollable).

At 110, a first user engagement metric may be assigned to a first content interface slot within the set of content interface slots. In an example, the first user engagement metric may indicate a probability of user engagement with supplemental content populated within the first content interface slot given the search query (e.g., “beach fun”), the content interest context (e.g., how likely the user would be to interact with a beach toy image collection given the search query “beach fun”, the beach location, the morning time, the social network post “Swimming today!”, the device form factor of the mobile device, the browser of the mobile device, etc.), and/or a position of the first content interface slot. The first user engagement metric may, for example, take into consideration a position bias of the first content interface slot given the search query and the content interest context (e.g., a position, size, and/or other visual features of the first content interface slot such that the user may notice and/or interact with the first content interface slot). In an example, the user may be inclined to interact with beach image collections that are populated in a horizontally scrollable interface, interspersed between search query results, for easy image navigation, while relaxing at the beach. In an example, the first user engagement metric may indicate a probably of a user impression (e.g., a likelihood the user notices supplemental content within the first content interface slot), a revenue generation opportunity (e.g., a likelihood the user will satisfy an advertising criteria of an advertisement, such as a click, an impression, or a purchase, through the first content interface slot), a spread of distinguishing search queries (e.g., the ability to provide the user with diverse information), etc.

At 112, a second user engagement metric may be assigned to the second content interface slot within the set of content interface slots. The second user engagement metric may be different than the first user engagement metric and may be based upon the search query, the content interest context and/or a position of the second content interface slot. In an example, the user may be more inclined to interact with related search topics that are populated in a side rail interface than if they were interspersed between search query results because the side rail interface may be more visually apparent to the user, whereas the user may overlook the related search topics if they were interspersed between search query results.

At 114, a content interface layout may be constructed on the search results canvas. In an example, the content interface layout may be constructed by assigning content interfaces, comprising supplemental content associated with the search query (e.g., a vacation social network posts collection, a beach photos collection from an image sharing service, a related topic search suggestion, etc.), to content interface slots so that content interfaces with relatively high quality content are assigned to content interface slots having relatively high user engagement probabilities. For example, a content interface may be assigned to a content interface slot based upon a probability that the user will engaged with supplemental content of the content interface given the search query (e.g., “beach fun”), a user engagement metric (e.g., corresponding to a position bias derived from a location of the content interface slot within the search results canvas), and/or the content interest context (e.g., the user may have an interest in swimming beach activities, but not night clubs, because it is morning time, the user is at the beach location, and the user recently posted the social network post “Swimming today!”). In an example, a content interface may be assigned to a content interface slot utilizing a two dimensional (2D) causally linked non-homogeneous Markov Random field and/or correlated component regression (CCR) estimation stabilization of judgment data and search log data. In an example, a content interface slot may be populated with a set of content interfaces according to an ordering that is derived from the content interest context (e.g., a content interface comprising highly interesting content (e.g., relative to the search query) may be ordered before other content interfaces with relatively less interesting content). In an example, various visual effects, such as a dim out visual effect and/or an attenuation effect, may be applied to a content interface based upon the content interest context.

In an example, a content interface may be assigned to a content interface slot based upon an exploration type of the content interface. For example, the content interface may be determined as having an exploration type comprising at least one of a related topic exploration type (e.g., the user may have a general interest in various types of content, such as fishing images, sand castle images, vacation videos, water sports, etc.), a drill down exploration type (e.g., where there user wants to focus into a particular type of content such as content about how to do the butterfly stroke), and/or a browsing exploration type (e.g., the user may have an interest in browsing beach images and/or other supplemental content related to the search query “beach fun”). The content interface may be assigned to a content interface slot corresponding to the exploration type (e.g., the horizontally scrollable interface may be amenable to the browsing exploration type because the user may easily scroll and browse through images or other supplemental content, the side rail interface may be amenable to the related topic exploration type because the user may be inclined to explore other topics that are presented adjacent to the search query results, the inline interface may be amendable to the drill down exploration type because the user may be come across the inline interface while scrolling and drill down into the search query results, etc.).

In an example, a first content interface, comprising first supplemental content associated with the search query, may be assigned to the first content interface slot based upon the first user engagement metric and the content interest context (e.g., a beach activities article collection may be populated within an inline interface positioned between one or more search query results because the user may have a high probability of engaging with the beach activities article collection when displayed through the inline interface). In an example, a second content interface, comprising second supplemental content associated with the search query, may be assigned to the second content interface slot based upon the second user engagement metric and the content interest context (e.g., a beach toys related topic search suggestion may be populated within a side rail interface because the user may have a high probability of interacting with the beach toys related topic search suggestion when displayed through the side rail interface). In this way, the content interface layout may be construct on the search results canvas, and may be display to the user. For example, the content interface layout may be constructed based upon a device type, browser type, and/or other form factor of the device so that the user may easily view the supplemental content within the content interfaces.

Because the content interface layout may be constructed based upon the content interest context, which may be different for different users and/or different for the same user under different circumstances, different content interface layouts may be constructed (e.g., different content interface layouts for different users and/or different content interface layouts for the same user such as based on changes to a content interest context (e.g., different date(s)/time(s), changes to a form factor, a recent social network post about going out to a beach night club, etc.). For example, the search query “beach fun” may be received from a second user of a second device. A second content interest context for the second user may be identified (e.g., the current time may be 9:00 pm, the second user may have recently submitted a search query “best bars in Miami”, etc.). A third user engagement metric may be assigned to the first content interface slot. The third user engagement metric may be the same or different than the first user engagement metric that was previously assigned to the first content interface slot for creating the content interface layout for the user (e.g., the second user may have a relatively lower probability of engaging in supplemental content populated within an inline interface than the user because the second user may be quickly looking for Miami bar nightlife content while leaving a hotel, and the second user may have a relatively higher likelihood of engaging with supplemental content within a horizontally scrollable interface populated above/before search query results than the user). A second content interface layout, different than the content interface layout, may be constructed where a third content interface, comprising third supplemental content (e.g., a night clubs related topic search query) associated with the search query, may be assigned to the first content interface slot based upon the third user engagement metric and the second content interest context. In this way, content interface layouts may be dynamically created and customized for particular users and content interest contexts. At 116, the method ends.

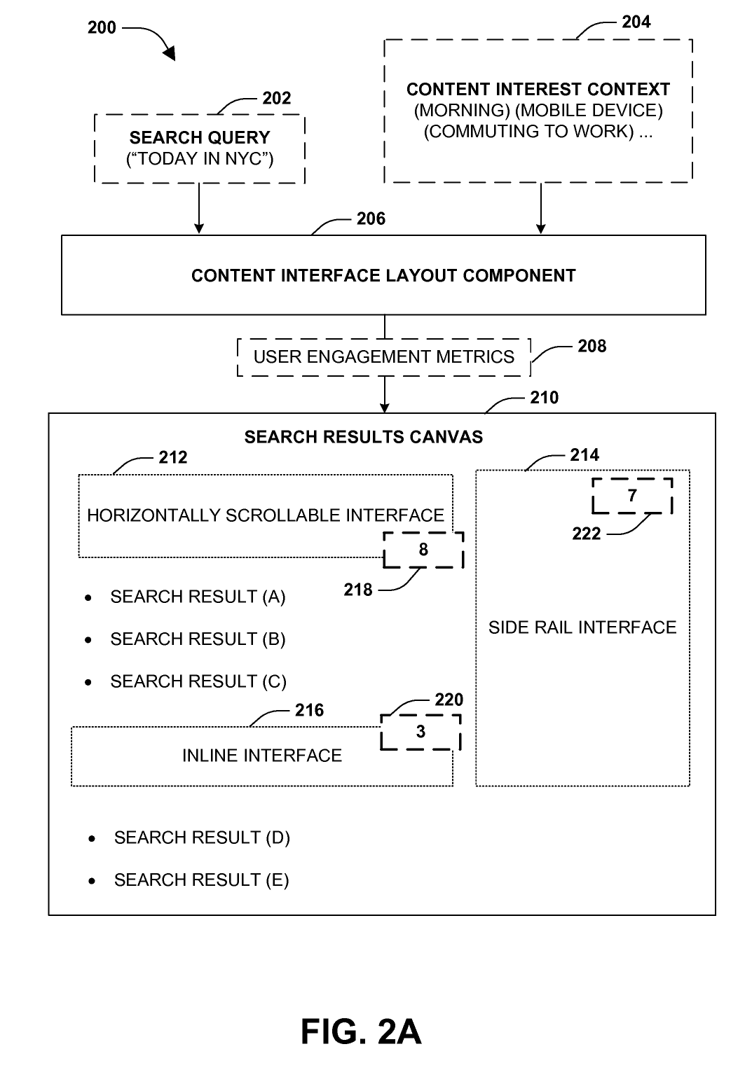

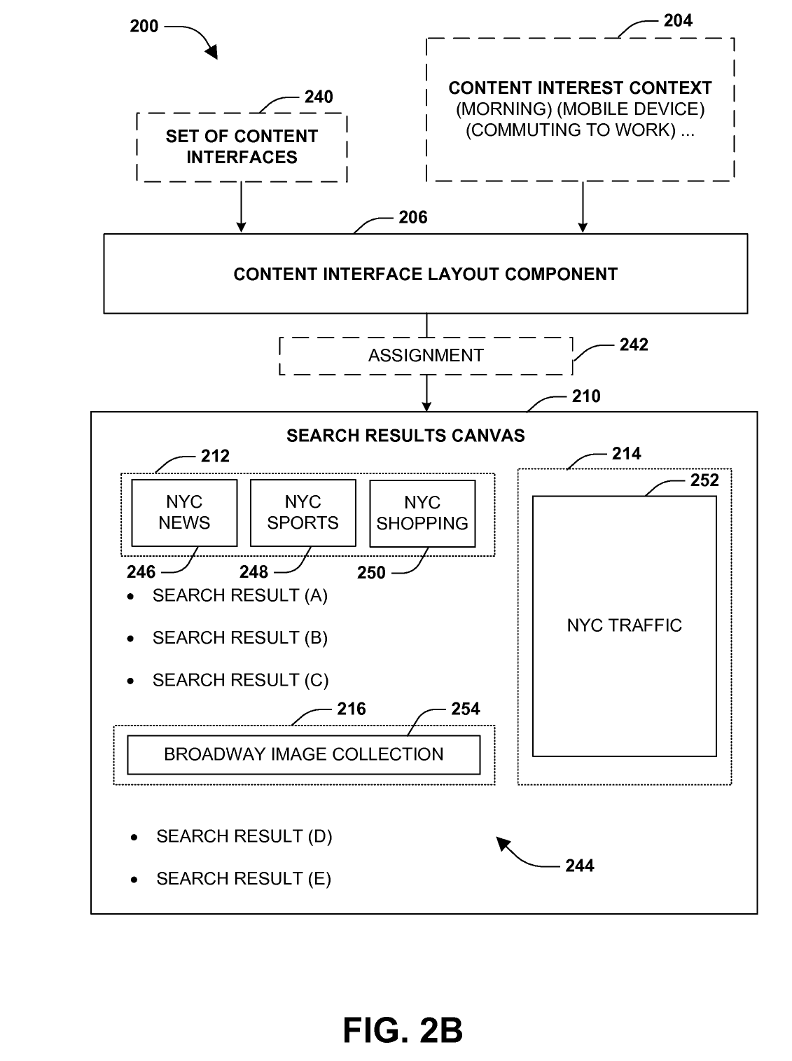

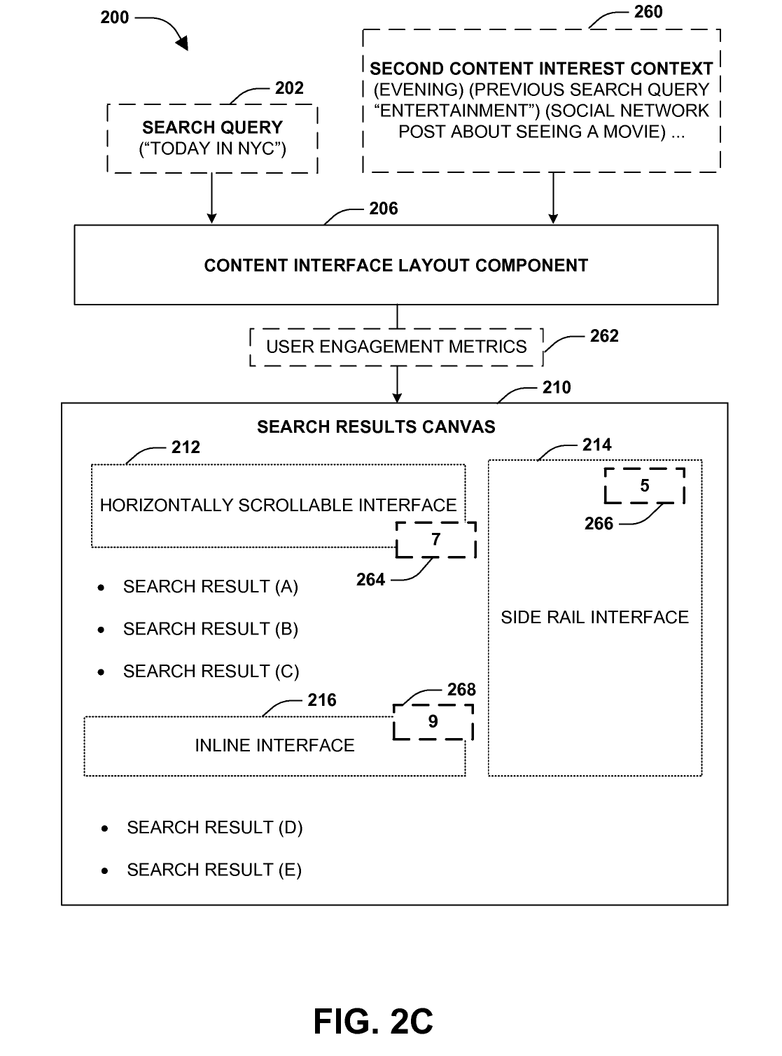

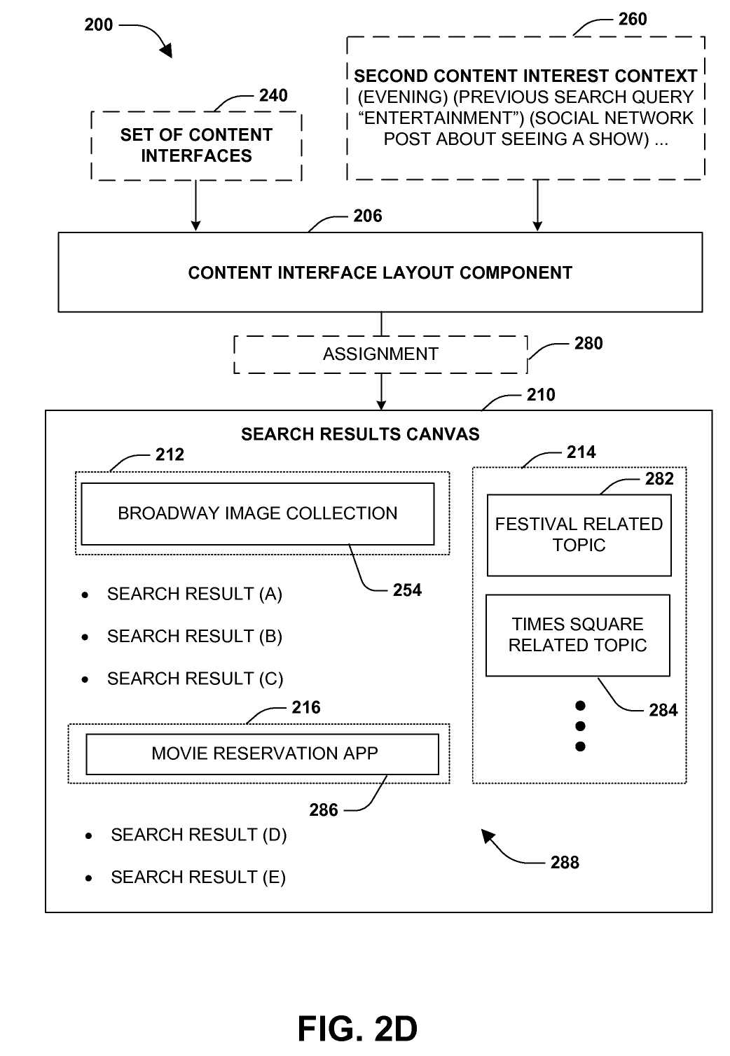

FIGS. 2A-2D illustrate examples of a system 200, comprising a content interface layout component 206, for constructing one or more content interface layouts. FIG. 2A illustrates the content interface layout component 206 receiving a search query “today in NYC” 202 from a user of a device. The content interface layout component 206 may identify a content interest context 204 for the user, such as a morning time, a mobile device type, a commuting to work current activity, and/or other information. The content interface layout component 206 may segment a search results canvas 210 into a set of content interface slots, such as a horizontally scrollable interface slot 212, a side rail interface slot 214, an inline interface slot 216, and/or other content interface slots not illustrated. In an example, at least some of the set of content interface slots are predefined for the search results canvas 210, and thus the search results canvas 210 is not segmented or is partially segmented by the content interface layout component 206. The content interface layout component 206 may assign user engagement metrics 208 to the content interface slots of the search results canvas 210 and/or at least some of such user engagement metrics may be preassigned for the content interface slots. For example, a first user engagement metric 218 of 8 out of 10 may be assigned to the horizontally scrollable interface slot 212 because the user may have a relatively high likelihood of interacting with supplemental content populated within the horizontally scrollable interface slot 212 (e.g., the user may be rushing to work and thus may merely look at the top portion of the search results canvas 210). A second user engagement metric 220 of 3 out of 10 may be assigned to the inline interface slot 216 because the user has a relatively low probability of scrolling down to the inline interface slot 216 to interact with supplemental content populated within the inline interface slot 216 (e.g., due to the user rushing to work). A third user engagement metric 222 of 7 out of 10 may be assigned to the side rail interface slot 214 because the user may have a relatively high probability of interacting with supplemental content populated within the side rail interface slot 214.

FIG. 2B illustrates the content interface layout component 206 assigning 242 content interfaces, within a set of content interfaces 240, to content interface slots to construct a content interface layout 244 on the search results canvas 210. For example, the content interface layout component 206 may assign a NYC news content interface 246, a NYC sports content interface 248, a NYC shopping content interface 250, and/or other content interfaces not illustrated to the horizontally scrollable interface slot 212 because the user may have a relatively high likelihood in engaging in such content interfaces and the horizontally scrollable interface slot 212 may have the relatively higher first user engagement metric 218 of 8 out of 10 (e.g., the user generally prefers to look at news, sports, and shopping content in the morning on the commute to work). The content interface layout component 206 may assign a Broadway image collection content interface 254 to the inline interface slot 216 because the user may have a relatively lower interest in viewing Broadway images and the inline interface slot 216 may have the relatively lower second user engagement metric 220 of 3 out of 10. The content interface layout component 206 may assign a NYC traffic content interface 252 to the side rail interface slot 214 because the user may have a relatively high likelihood of engaging with traffic content during the user's morning commute to work and the side rail interface slot 214 may have the relatively higher third user engagement metric 222 of 7 out of 10.

FIG. 2C illustrates an example where the user submits the same search query “today in NYC” 202 but at a different time of day and/or according to a different content interest context. For example, the content interface layout component 206 may identify a second content interest 260 for the user, such as an evening time, a previous search query “entertainment”, a recent social network post about seeing a show, a home computer with a desktop browser, and/or other information. The content interface layout component 206 may assign user engagement metrics 262 to the content interface slots of the search results canvas 210 and/or at least some of the user engagement metrics may be preassigned. For example, a fourth user engagement metric 264 of 7 out of 10 may be assigned to the horizontally scrollable interface slot 212 because the user may have a relatively high likelihood of interacting with supplemental content populated within the horizontally scrollable interface slot 212 (e.g., the user may be have a tendency to scroll through easily visible content when searching for entertainment content). A fifth user engagement metric 268 of 9 out of 10 may be assigned to the inline interface slot 216 because the user has a relatively high probability of scrolling down through search results to the inline interface slot 216 in order to interact with supplemental content populated within the inline interface slot 216 (e.g., the user has a tendency to browse and explore content, such as by scrolling through search results, for entertainment ideas). A sixth user engagement metric 266 of 5 out of 10 may be assigned to the side rail interface slot 214 because the user may have a relatively medium probability of interacting with supplemental content populated within the side rail interface slot 214 (e.g., the user may have a tendency to scroll up and down instead of seeking supplemental content that is adjacent to the search query results).

FIG. 2D illustrates the content interface layout component 206 assigning 280 content interfaces, within the set of content interfaces 240, to content interface slots to construct a content interface layout 288 on the search results canvas 210. For example, the content interface layout component 206 may assign the Broadway image collection content interface 254 to the horizontally scrollable interface slot 212 because the user may have a relatively high likelihood to engage with Broadway images and the horizontally scrollable interface slot 212 may have the relatively higher third user engagement metric 264 of 7 out of 10 (e.g., the user may have a high likelihood of scrolling through Broadway images based upon the previous search query of “entertainment” and the social network post about seeing a show). The content interface layout component 206 may assign a movie reservation app content interface 286 (e.g., linking to a movie reservation app available through an app store) to the inline interface slot 216 because the user may have a relatively high interest in purchasing movie tickets and the inline interface slot 216 may have the relatively higher fourth user engagement metric 268 of 9 out of 10 (e.g., the user may have a high likelihood of scrolling through search results to the inline interface slot 216 and engaging with the movie reservation app content interface 286). The content interface layout component 206 may assign a festival related topic search suggestion content interface 282 and a Times Square related topic search suggestion content interface 284 (e.g., used to provide the user with a spread of distinguishing queries) to the side rail interface slot 214 because the user may have a relatively medium likelihood of engaging with such content interfaces and of engaging with supplemental content within the side rail interface slot 214. In this way, content interface layouts may be dynamically created and tailored to particular users and/or content interest contexts.

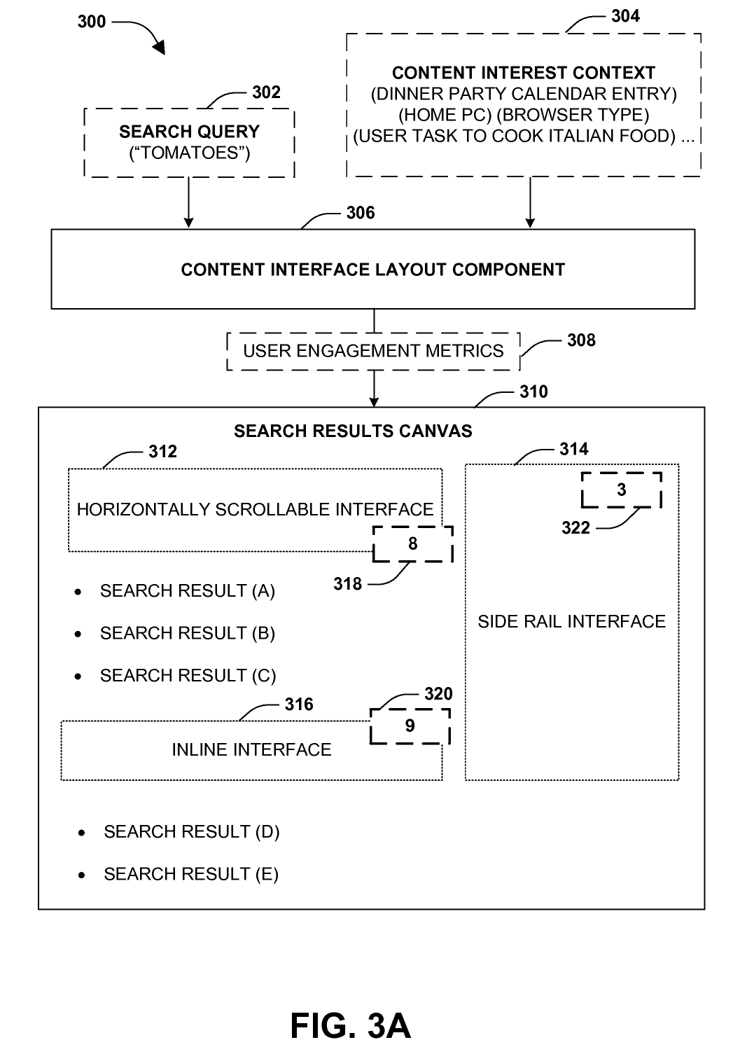

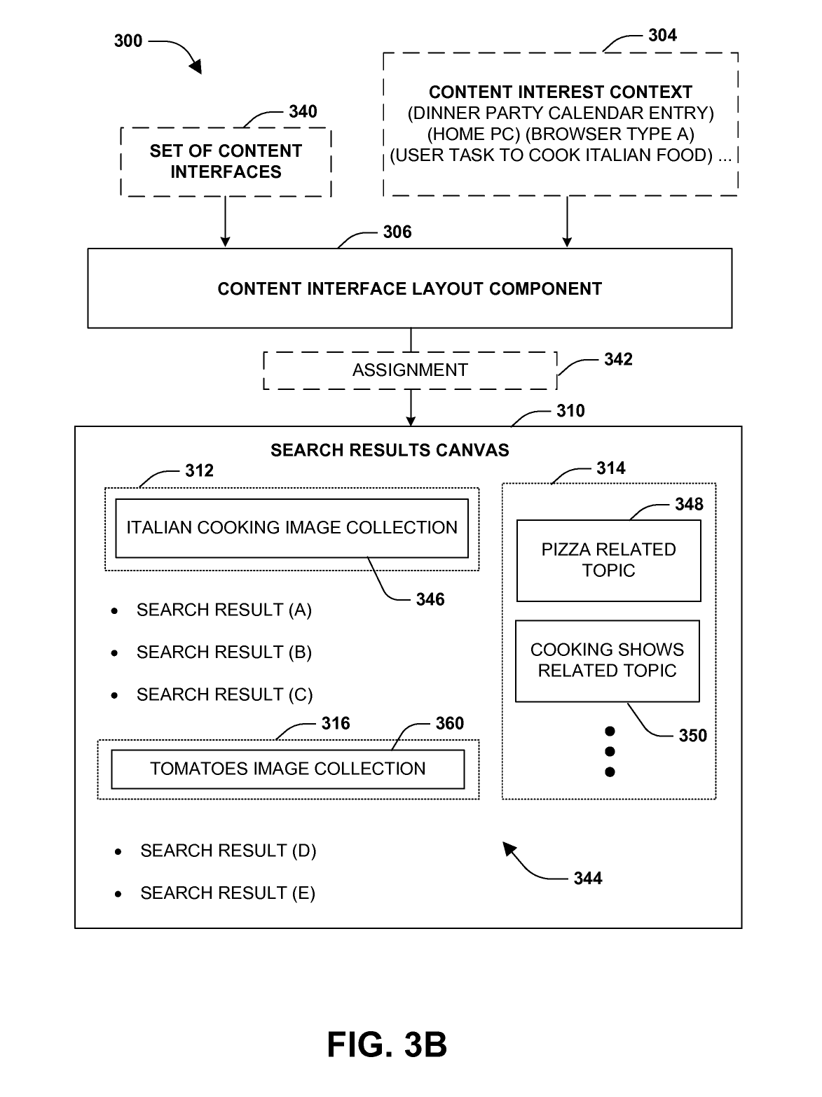

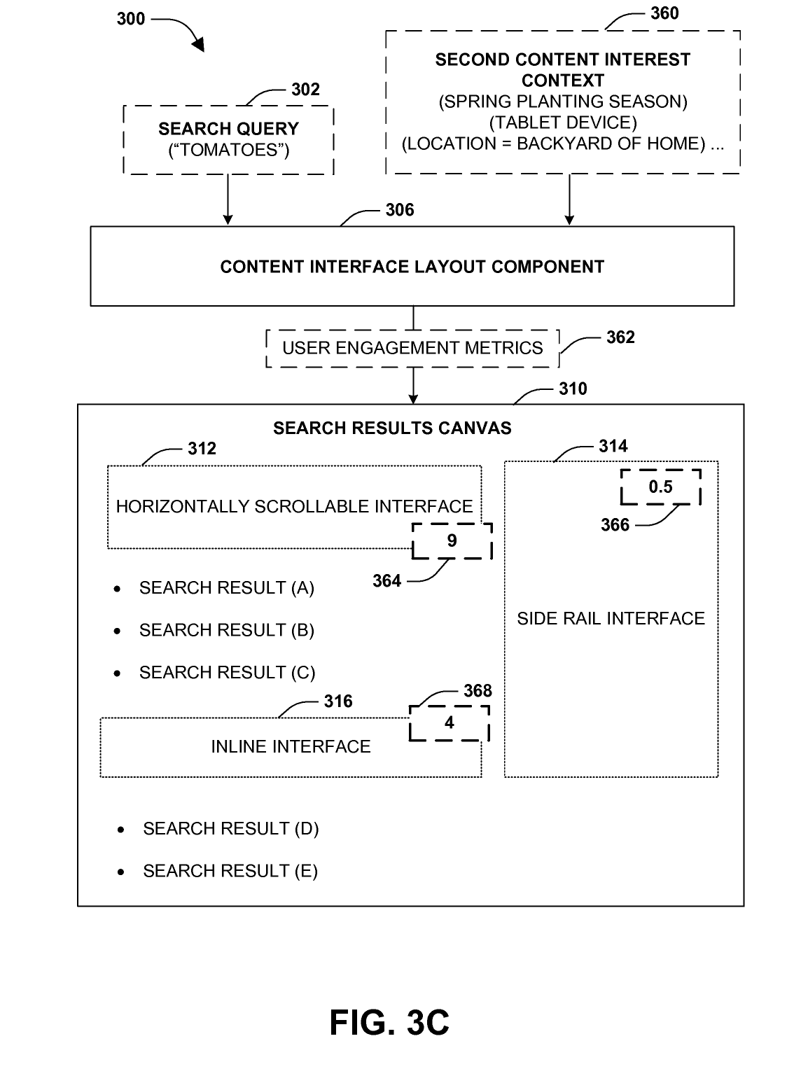

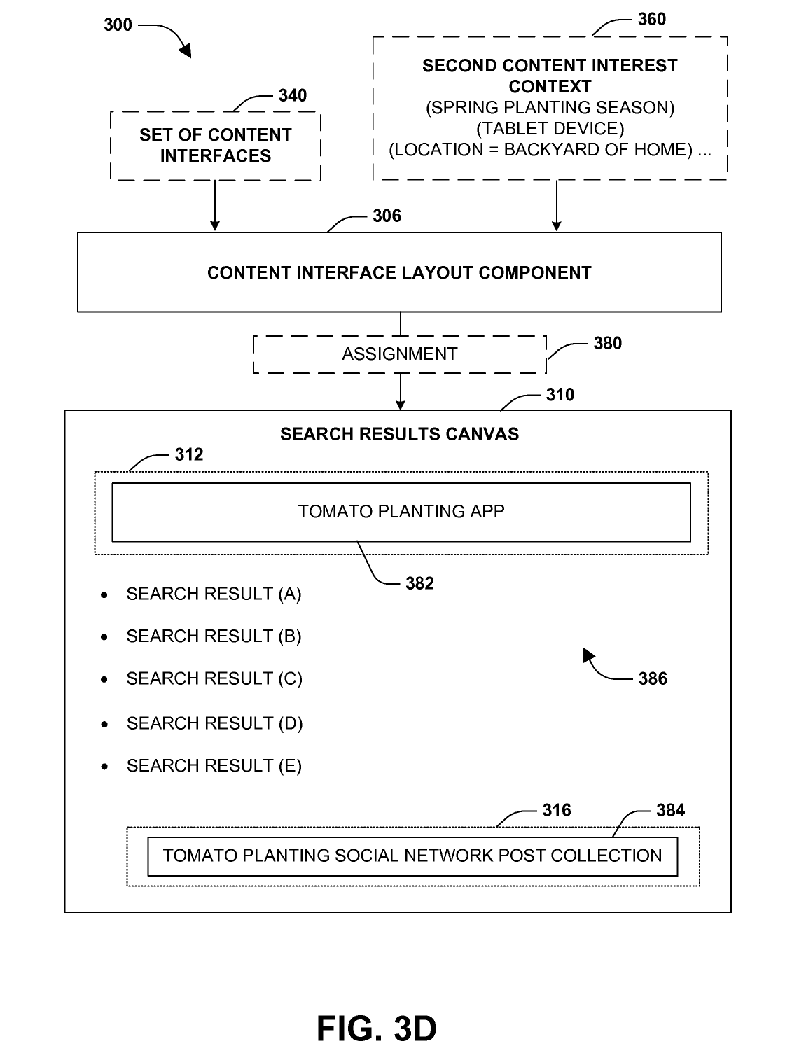

FIGS. 3A-3D illustrate examples of a system 300, comprising a content interface layout component 306, for constructing a first content interface layout for a first user and a second content interface layout for a second user based upon the same search query. FIG. 3A illustrates the content interface layout component 306 receiving a search query “tomatoes” 302 from the first user of a first device. The content interface layout component 306 may identify a first content interest context 304 for the first user, such as a dinner party calendar entry, a home personal computer device type, a browser type, a user task to cook Italian food, and/or other information. The content interface layout component 306 may segment a search results canvas 310 into a set of content interface slots, such as a horizontally scrollable interface slot 312, a side rail interface slot 314, an inline interface slot 316, and/or other content interface slots not illustrated. In an example, at least some of the set of content interface slots are predefined for the search results canvas 310, and thus the search results canvas 310 is not segmented or is partially segmented by the content interface layout component 306. The content interface layout component 306 may assign user engagement metrics 308 to the content interface slots of the search results canvas 310 and/or at least some of such user engagement metrics may be preassigned for the content interface slots. For example, a first user engagement metric 318 of 8 out of 10 may be assigned to the horizontally scrollable interface slot 312 because the first user may have a relatively high likelihood of interacting with supplemental content populated within the horizontally scrollable interface slot 312. A second user engagement metric 320 of 9 out of 10 may be assigned to the inline interface slot 316 because the first user has a relatively high probability of scrolling down to the inline interface slot 316 to interact with supplemental content populated within the inline interface slot 316 (e.g., while at home, the user may be inclined to take time to scroll down through search results and explore content interfaces that may not be immediately visible). A third user engagement metric 322 of 3 out of 10 may be assigned to the side rail interface slot 314 because the user may have a relatively low probability of interacting with supplemental content populated within the side rail interface slot 314 (e.g., the user tends to not interact with content adjacent to search results).

FIG. 3B illustrates the content interface layout component 306 assigning 342 content interfaces, within a set of content interfaces 340, to content interface slots to construct a content interface layout 344 on the search results canvas 310. For example, the content interface layout component 306 may assign an Italian cooking image collection content interface 346 (e.g., corresponding to an image collection sharing social network service) to the horizontally scrollable interface slot 312 because the first user may have a relatively high likelihood to engage with Italian cooking images and the horizontally scrollable interface slot 312 may have the relatively higher first user engagement metric 318 of 8 out of 10. The content interface layout component 306 may assign a tomatoes image collection content interface 360 to the inline interface slot 316 because the first user may have a relatively high interest in viewing tomato images and the inline interface slot 316 may have the relatively higher second user engagement metric 320 of 9 out of 10. The content interface layout component 306 may assign a pizza related topic search suggestion content interface 348 and a cooking shows related topic search suggestion 350 to the side rail interface slot 314 because the first user may have a relatively lower likelihood of exploring related topics (e.g., the first user may be focused, such as deep diving, into tomato based cooking) and the side rail interface slot 314 may have the relatively lower third user engagement metric 322 of 3 out of 10.

FIG. 3C illustrates the content interface layout component 306 receiving the search query “tomatoes” 302 from the second user of a second device. The content interface layout component 306 may identify a second content interest context 360 for the second user, such as a springtime planting season, a tablet device type, a current location of being in the second user's backyard, and/or other information. The content interface layout component 306 may perform an initial segmentation of the search results canvas 310 into a set of content interface slots, such as the horizontally scrollable interface slot 312, the side rail interface slot 314, the inline interface slot 316, and/or other content interface slots not illustrated. In an example, at least some of the set of content interface slots are predefined for the search results canvas 310, and thus the search results canvas 310 is not segmented or is partially segmented by the content interface layout component 306.

The content interface layout component 306 may assign user engagement metrics 362 to the content interface slots of the search results canvas 310 and/or at least some of such user engagement metrics may be preassigned for the content interface slots. For example, a fourth user engagement metric 364 of 9 out of 10 may be assigned to the horizontally scrollable interface slot 312 because the second user may have a relatively high likelihood of interacting with supplemental content populated within the horizontally scrollable interface slot 312. A fifth user engagement metric 368 of 4 out of 10 may be assigned to the inline interface slot 316 because the second user has a relatively medium probability of scrolling down to the inline interface slot 316 to interact with supplemental content populated within the inline interface slot 316 (e.g., because the second user may be actively planning a garden and may not desire to take the time to scroll through search results to see supplemental content). A sixth user engagement metric 366 of 0.5 out of 10 may be assigned to the side rail interface slot 314 because the second user may have a relatively low probability of interacting with supplemental content populated within the side rail interface slot 314 (e.g., the second user may generally view related topic search suggestions in the side rail interface slot 314, but may currently have no interest in exploring related topics because the second user is currently attempting to deep dive into completing a gardening task). Because the sixth user engagement metric 366 is below an engagement threshold, the side rail interface 314 may be removed and the horizontally scrollable interface 312 and the inline interface 316 may be enlarged and/or moved as a new segmentation of the search results canvas 310, as illustrated in FIG. 3D, which may free up screen real estate of the tablet device for deep dive content as opposed to uninteresting related topics.

FIG. 3D illustrates the content interface layout component 306 assigning 380 content interfaces, within the set of content interfaces 340, to content interface slots to construct a second content interface layout 386 on the search results canvas 310. For example, the content interface layout component 306 may assign a tomato planting app content interface 382 (e.g., linking to a tomato planting app available from an app store) to the horizontally scrollable interface slot 312 because the second user may have a relatively high likelihood to engage with the tomato planting app and the horizontally scrollable interface slot 312 may have the relatively higher fourth user engagement metric 364 of 9 out of 10 (e.g., the second user may have a strong desire to download the tomato planting app so that the second user can immediately use the tomato planting app to aid in the second user's gardening efforts). The content interface layout component 306 may assign a tomato planting social network post collection content interface 384 to the inline interface slot 316 because the second user may have a relatively medium interest in viewing other user's tomato planting images and the inline interface slot 316 may have the relatively medium fifth user engagement metric 368 of 4 out of 10. In this way, content interface layouts may be dynamically created and tailored to particular users and/or content interest contexts.

According to an aspect of the instant disclosure, a method for constructing a content interface layout is provided. The method includes a receiving a search query from a user of a device. The method includes identifying a content interest context for the user. The method includes segmenting a search results canvas for the search query into a set of content interface slots. The method includes assigning a first user engagement metric to a first content interface slot within the set of content interface slots. The method includes assigning a second user engagement metric to a second content interface slot within the set of content interface slots. The method includes constructing a content interface layout on the search results canvas. The method includes assigning a first content interface, comprising first supplemental content associated with the search query, to the first content interface slot based upon the first user engagement metric and the content interest context. The method includes assigning a second content interface, comprising second supplemental content associated with the search query, to the second content interface slot based upon the second user engagement metric and the content interest context.

According to an aspect of the instant disclosure, a system for constructing a content interface layout is provided. The system includes a content interface layout component. The content interface layout component is configured to receive a search query from a user of a device. The content interface layout component is configured identify a content interest context for the user. The content interface layout component is configured segment a search results canvas for the search query into a set of content interface slots. The content interface layout component is configured assign a first user engagement metric to a first content interface slot within the set of content interface slots. The content interface layout component is configured assign a second user engagement metric to a second content interface slot within the set of content interface slots. The content interface layout component is configured construct a content interface layout on the search results canvas. The content interface layout component is configured assign a first content interface, comprising first supplemental content associated with the search query, to the first content interface slot based upon the first user engagement metric and the content interest context. The content interface layout component is configured assign a second content interface, comprising second supplemental content associated with the search query, to the second content interface slot based upon the second user engagement metric and the content interest context.

According to an aspect of the instant disclosure, a computer readable medium comprising instructions which when executed performs a method for constructing a content interface layout is provided. The method includes a receiving a search query from a user of a device. The method includes identifying a content interest context for the user. The method includes segmenting a search results canvas for the search query into a set of content interface slots. The method includes assigning a first user engagement metric to a first content interface slot within the set of content interface slots. The method includes assigning a second user engagement metric to a second content interface slot within the set of content interface slots. The method includes constructing a content interface layout on the search results canvas. The method includes assigning a first content interface, comprising first supplemental content associated with the search query, to the first content interface slot based upon the first user engagement metric and the content interest context. The method includes assigning a second content interface, comprising second supplemental content associated with the search query, to the second content interface slot based upon the second user engagement metric and the content interest context.

According to an aspect of the instant disclosure, a means for constructing a content interface layout is provided. A search query from a user of a device is received, by the means for constructing a content interface layout. A content interest context for the user is identified, by the means for constructing a content interface layout. A search results canvas for the search query is segmented into a set of content interface slots, by the means for constructing a content interface layout. A first user engagement metric is assigned to a first content interface slot within the set of content interface slots, by the means for constructing a content interface layout. A second user engagement metric is assigned to a second content interface slot within the set of content interface slots, by the means for constructing a content interface layout. A content interface layout is constructed on the search results canvas, by the means for constructing a content interface layout. A first content interface, comprising first supplemental content associated with the search query, is assigned to the first content interface slot based upon the first user engagement metric and the content interest context, by the means for constructing a content interface layout. A second content interface, comprising second supplemental content associated with the search query, is assigned to the second content interface slot based upon the second user engagement metric and the content interest context, by the means for constructing a content interface layout.

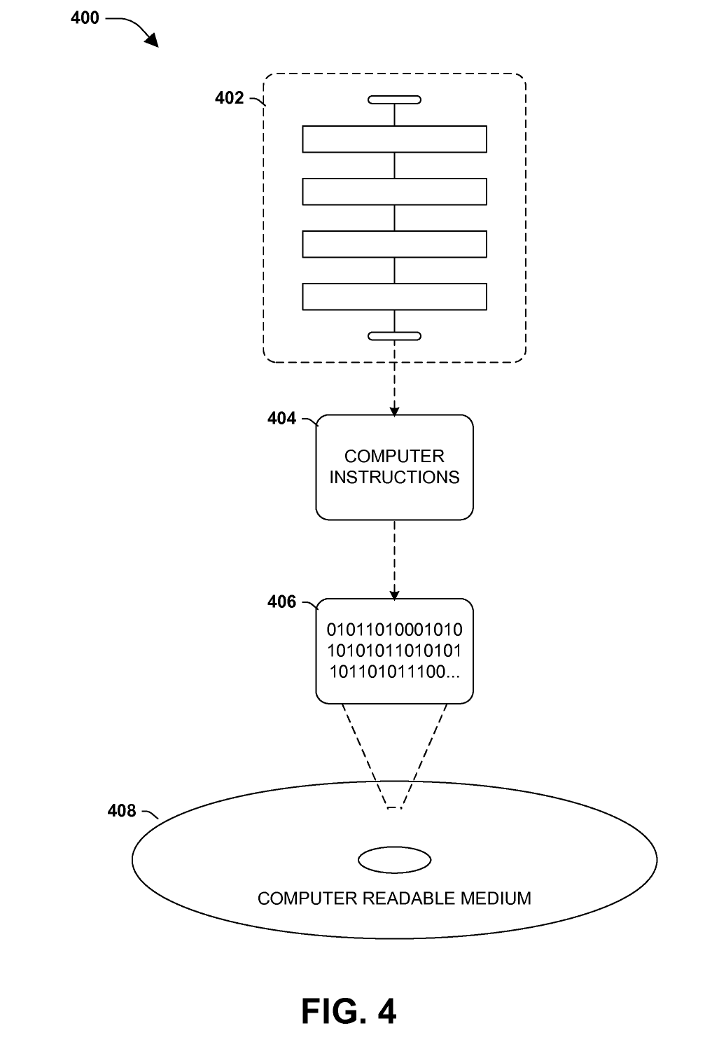

Still another embodiment involves a computer-readable medium comprising processor-executable instructions configured to implement one or more of the techniques presented herein. An example embodiment of a computer-readable medium or a computer-readable device is illustrated in FIG. 4, wherein the implementation 400 comprises a computer-readable medium 408, such as a CD-R, DVD-R, flash drive, a platter of a hard disk drive, etc., on which is encoded computer-readable data 406. This computer-readable data 406, such as binary data comprising at least one of a zero or a one, in turn comprises a set of computer instructions 404 configured to operate according to one or more of the principles set forth herein. In some embodiments, the processor-executable computer instructions 404 are configured to perform a method 402, such as at least some of the exemplary method 100 of FIG. 1, for example. In some embodiments, the processor-executable instructions 404 are configured to implement a system, such as at least some of the exemplary system 200 of FIGS. 2A-2D and/or at least some of the exemplary system 300 of FIGS. 3A-3D, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

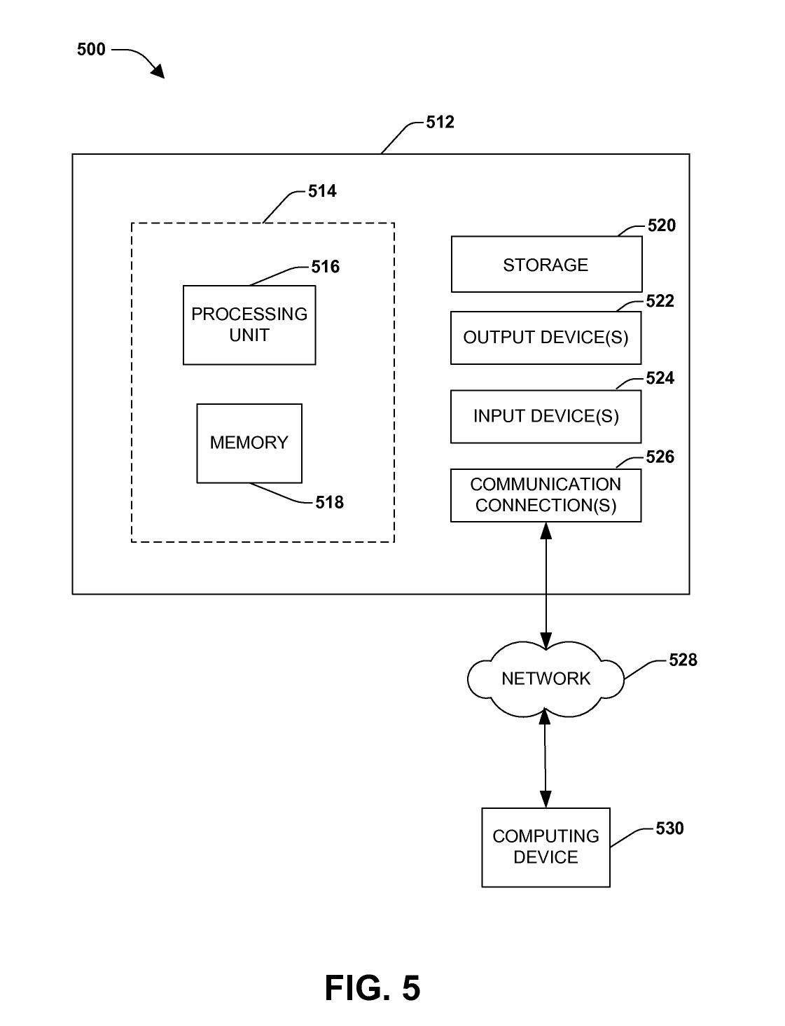

FIG. 5 and the following discussion provide a brief, general description of a suitable computing environment to implement embodiments of one or more of the provisions set forth herein. The operating environment of FIG. 5 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 5 illustrates an example of a system 500 comprising a computing device 512 configured to implement one or more embodiments provided herein. In one configuration, computing device 512 includes at least one processing unit 516 and memory 518. Depending on the exact configuration and type of computing device, memory 518 may be volatile (such as RAM, for example), non-volatile (such as ROM, flash memory, etc., for example) or some combination of the two. This configuration is illustrated in FIG. 5 by dashed line 514.

In other embodiments, device 512 may include additional features and/or functionality. For example, device 512 may also include additional storage (e.g., removable and/or non-removable) including, but not limited to, magnetic storage, optical storage, and the like. Such additional storage is illustrated in FIG. 5 by storage 520. In one embodiment, computer readable instructions to implement one or more embodiments provided herein may be in storage 520. Storage 520 may also store other computer readable instructions to implement an operating system, an application program, and the like. Computer readable instructions may be loaded in memory 518 for execution by processing unit 516, for example.

The term “computer readable media” as used herein includes computer storage media. Computer storage media includes volatile and nonvolatile, removable and non-removable media implemented in any method or technology for storage of information such as computer readable instructions or other data. Memory 518 and storage 520 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 512. Computer storage media does not, however, include propagated signals. Rather, computer storage media excludes propagated signals. Any such computer storage media may be part of device 512.

Device 512 may also include communication connection(s) 526 that allows device 512 to communicate with other devices. Communication connection(s) 526 may include, but is not limited to, a modem, a Network Interface Card (NIC), an integrated network interface, a radio frequency transmitter/receiver, an infrared port, a USB connection, or other interfaces for connecting computing device 512 to other computing devices. Communication connection(s) 526 may include a wired connection or a wireless connection. Communication connection(s) 526 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 512 may include input device(s) 524 such as keyboard, mouse, pen, voice input device, touch input device, infrared cameras, video input devices, and/or any other input device. Output device(s) 522 such as one or more displays, speakers, printers, and/or any other output device may also be included in device 512. Input device(s) 524 and output device(s) 522 may be connected to device 512 via a wired connection, wireless connection, or any combination thereof. In one embodiment, an input device or an output device from another computing device may be used as input device(s) 524 or output device(s) 522 for computing device 512.

Components of computing device 512 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 512 may be interconnected by a network. For example, memory 518 may be comprised of multiple physical memory units located in different physical locations interconnected by a network.

Those skilled in the art will realize that storage devices utilized to store computer readable instructions may be distributed across a network. For example, a computing device 530 accessible via a network 528 may store computer readable instructions to implement one or more embodiments provided herein. Computing device 512 may access computing device 530 and download a part or all of the computer readable instructions for execution. Alternatively, computing device 512 may download pieces of the computer readable instructions, as needed, or some instructions may be executed at computing device 512 and some at computing device 530.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B and/or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for constructing a content interface layout, comprising:
receiving a search query from a user of a device;
identifying a content interest context for the user;
segmenting a search results canvas for the search query into a set of content interface slots;
assigning a first user engagement metric to a first content interface slot within the set of content interface slots;
assigning a second user engagement metric to a second content interface slot within the set of content interface slots; and
constructing a content interface layout on the search results canvas, comprising:
assigning a first content interface, comprising first supplemental content associated with the search query, to the first content interface slot based upon the first user engagement metric and the content interest context; and
assigning a second content interface, comprising second supplemental content associated with the search query, to the second content interface slot based upon the second user engagement metric and the content interest context.

2. The method of claim 1, at least one of the first user engagement metric or the second user engagement metric indicating a probability of at least one of user engagement, a user impression, a revenue generation opportunity, or a spread of distinguishing search queries.

3. The method of claim 1, a content interface slot comprising a horizontally scrollable interface.

4. The method of claim 1, a content interface slot comprising an inline interface positioned between one or more search query results.

5. The method of claim 1, a content interface slot comprising a side rail interface positioned adjacent to a search query result.

6. The method of claim 1, the assigning a first content interface comprising:
determining an exploration type of the first content interface, the exploration type comprising at least one of a related topic exploration type, a drill down exploration type, or a browsing exploration type; and
assigning the first content interface to the first content interface slot based upon the first content interface slot corresponding to the exploration type.

7. The method of claim 1, the first content interface comprising at least one of a related topic content interface, a content collection content interface, an image collection content interface, a social network content interface, or a tile content interface.

8. The method of claim 1, comprising:
applying a dim out visual effect to the first content interface based upon the content interest context.

9. The method of claim 1, comprising:
applying an attenuation effect to the first content interface based upon the content interest context.

10. The method of claim 4, comprising:
populating the inline interface with a set of content interfaces according to an order derived from the content interest context.

11. The method of claim 5, comprising:
populating the side rail interface with a set of content interfaces according to an order derived from the content interest context.

12. The method of claim 1, comprising:
receiving the search query from a second user;
identifying a second content interest context for the second user;
assigning a third user engagement metric to the first content interface slot; and
constructing a second content interface layout different than the content interface layout, comprising:
assigning a third content interface, comprising third supplemental content associated with the search query, to the first content interface slot based upon the third user engagement metric and the second content interest context.

13. The method of claim 1, the content interest context corresponding to a current date and time.

14. The method of claim 1, the content interest context corresponding to at least one of a query intent, a relevancy between the search query and supplemental content of a content interface, a device type, a user location, a browser type, a user task, previously engaged content, a previously submitted search query, a quality metric for the content interface, or a user profile.

15. The method of claim 1, the assigning a first user engagement metric to a first content interface slot, comprising:
assigning the first user engagement metric to the first content interface slot based upon a first position bias of the first content interface slot given the search query and the content interest context.

16. A system for constructing a content interface layout, comprising:
a content interface layout component configured to:
receive a search query from a user of a device;
identify a content interest context for the user;
segment a search results canvas for the search query into a set of content interface slots;
assign a first user engagement metric to a first content interface slot within the set of content interface slots;
assign a second user engagement metric to a second content interface slot within the set of content interface slots; and
construct a content interface layout on the search results canvas, comprising:
assign a first content interface, comprising first supplemental content associated with the search query, to the first content interface slot based upon the first user engagement metric and the content interest context; and
assign a second content interface, comprising second supplemental content associated with the search query, to the second content interface slot based upon the second user engagement metric and the content interest context.

17. The system of claim 16, the content interface layout component configured to:
determine a first exploration type of the first content interface, the first exploration type comprising at least one of a related topic exploration type, a drill down exploration type, or a browsing exploration type; and
assign the first content interface to the first content interface slot based upon the first content interface slot corresponding to the first exploration type.

18. The system of claim 16, the first content interface comprising at least one of a related topic content interface, a content collection content interface, an image collection content interface, a social network content interface, or a tile content interface.

19. The system of claim 16, a content interface slot comprising a horizontally scrollable interface.

20. A computer readable medium comprising instructions which when executed perform a method for constructing a content interface layout, comprising:
receiving a search query from a user of a device;
identifying a content interest context for the user;
segmenting a search results canvas for the search query into a set of content interface slots;
assigning a first user engagement metric to a first content interface slot within the set of content interface slots;
assigning a second user engagement metric to a second content interface slot within the set of content interface slots; and
constructing a content interface layout on the search results canvas, comprising:
assigning a first content interface, comprising first supplemental content associated with the search query, to the first content interface slot based upon the first user engagement metric and the content interest context; and
assigning a second content interface, comprising second supplemental content associated with the search query, to the second content interface slot based upon the second user engagement metric and the content interest context.
